(19) United States
(12) Patent Application Publication
(10) Pub. No.: US 2003/0057026 A1
(43) Pub. Date: Mar. 27, 2003

(54) Method of marketing using re-usable bags

(76) Inventor: Michel Poirier, Loretteville (CA)

Correspondence Address: AIKINS, MACAULAY & THORVALDSON, 30TH FLOOR COMMODITY EXCHANGE TOWER, 360 MAIN STREET, WINNIPEG, MB, R3C 4G1, CA

(21) Appl. No.: 09/963,524

(22) Filed: Sep. 27, 2001

(51) Int. Cl. B61B 1/00; B65G 1/00; E04H 3/00

(52) U.S. Cl. 186/52

(57) ABSTRACT

Merchandise is marketed from the premises of a merchant from which the merchandise is normally transported in bags supplied by the merchant. This may, for example, be a grocery store. The merchant provides customers with re-usable bags for transporting their purchases. These bags may be sold to the customers or they may be given away as a promotion. Each customer who returns to the store with the re-usable bags receives an award on the acquisition newly acquired merchandise. The award may be a discount on the newly acquired merchandise, a reward in a reward program or any other product or service that will attract customers. The newly acquired merchandise may be restricted to selected products identified by displays or advertising. Where a particular manufacturer's or supplier's product is selected as a product triggering a discount or is being offered at a discount, the manufacturer or supplier may pay the merchant or provide some other consideration. The method encourages customers to use re-usable bags, which reduces waste. The merchant and his suppliers benefit from returning customers and product promotion. The bags may carry advertising, possibly sold by the merchant to suppliers.

### FIELD OF THE INVENTION

The present invention relates to a method of marketing using re-usable shopping bags.

### BACKGROUND

With an emphasis on reducing costs and minimizing waste, efforts have been made to increase the recycling of various items that have conventionally been discarded. One example is grocery and other shopping bags, which are being reused with increasing frequency. The present invention is concerned with a method of marketing that enhances the value of reusable shopping bags for both the consumer and the merchant, and thus encourages the use of the reusable bags.

### SUMMARY

According to one aspect of the present invention there is provided a method of marketing merchandise at a merchant's premises from which merchandise is normally transported in bags supplied by the merchant, said method comprising:

providing customers with re-usable bags for transporting their merchandise;

providing each customer returning to the store with one or more of the re-usable bags with an award on the acquisition newly acquired merchandise.

The award may be a discount on the newly acquired merchandise, a reward in a reward program or any other product or service that will attract customers.

The newly acquired merchandise may be restricted to selected products identified by in-store displays or other advertising, for example newspaper, television and circular advertisements. Where a particular manufacturer's or supplier's product is selected as a product triggering a discount or is being offered at a discount, the manufacturer or supplier may pay the merchant or provide some other consideration for offering the discount, thus subsidizing the re-usable bag promotion.

Another aspect of the method is the use of advertising on the re-usable bags. This may identify the merchant, some other party or particular products or services. In most cases, the merchant will wish to have the bag carry the merchant's own advertising, even if other advertisements are presented. This not only advertises the merchant's marketing campaign, but ensures that only the merchant's bags are used for gaining awards.

The bags may be given to customers free of charge, or they may be sold, possibly at a discount.

### BRIEF DESCRIPTION OF THE DRAWINGS

In the accompanying drawings, which illustrate an exemplary embodiment of the present invention:

FIG. 1 is a schematic representation of the purchase of groceries according to the present invention;

FIG. 2 is a flow chart representation of the method; and

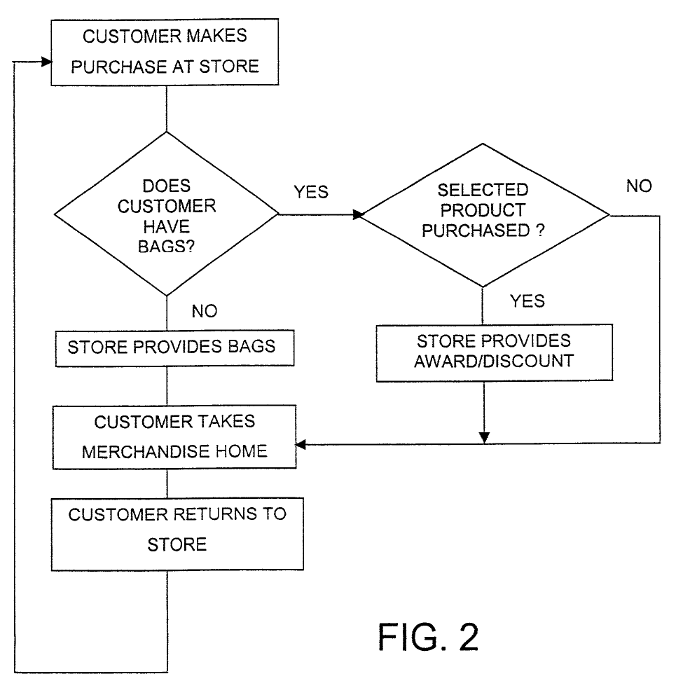

FIG. 3 is an isometric view of a shopping bag.

### DETAILED DESCRIPTION

Referring to the drawings, a retail grocery store 10 sells re-usable grocery bags 12 to a customer 14. The customer uses the bags to carry purchases from the store to the customer's home 16. On returning to the store with the bags 12, and making a further purchase of selected merchandise, the customer is given a discount on the price of that merchandise.

In this embodiment, the merchandise that attracts a discount is selected by the merchant and suppliers to the merchant. The discounts are advertised in appropriate media or in other ways to attract customers to the store and to encourage them to purchase the products in question.

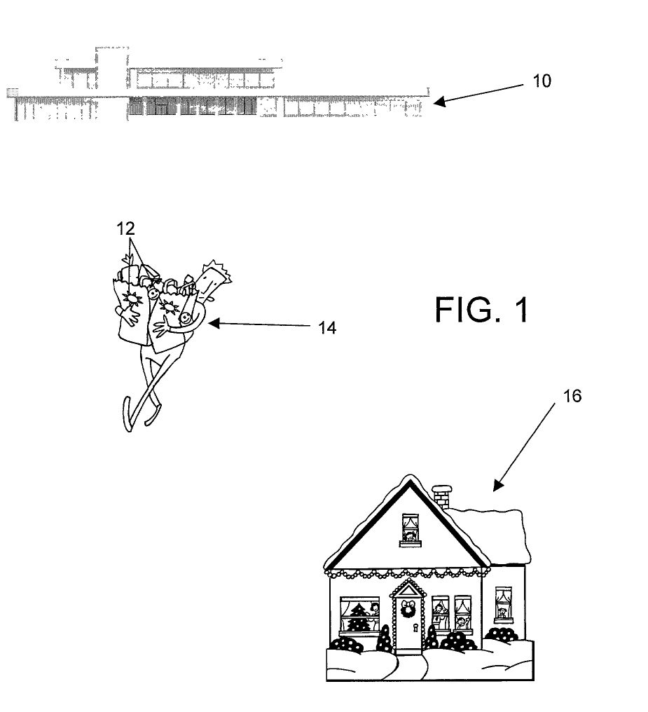

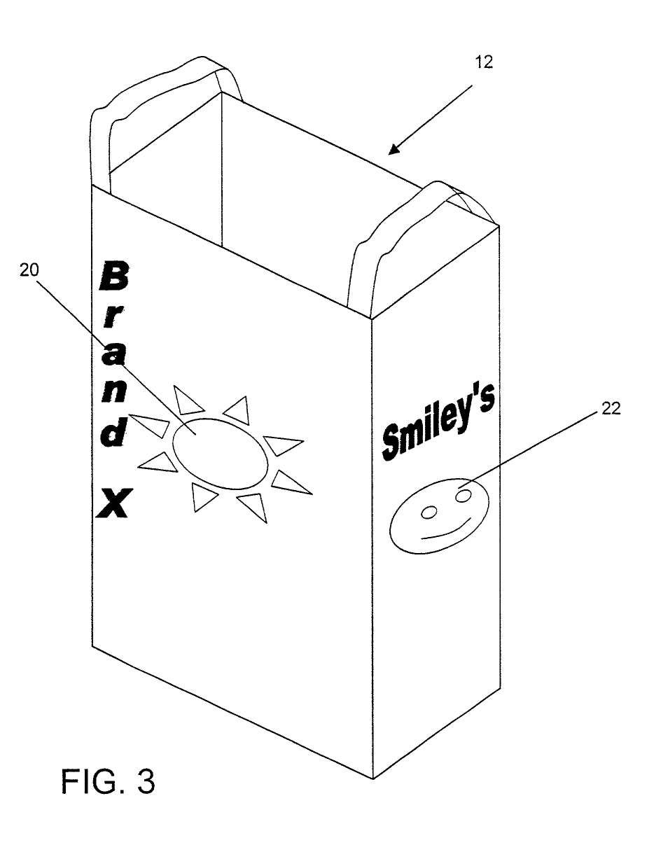

As illustrated in FIG. 3, the grocery bag 12 is printed with a logo 20 representing the store 10 (FIG. 1). It also carries a logo 22 representing a certain product or products carried by the store or certain suppliers to the store. This makes the bag a joint promotion to which the various advertisers may contribute. The bag advertisers will also benefit from participation in the provision of awards for the re-use of the bags.

While one particular embodiment of the invention has been described in the foregoing, it is to be understood that other embodiments are possible within the spirit and scope of the invention. The invention is to be considered limited solely by the scope of the appended claims.

1. A method of marketing merchandise at a merchant's premises from which merchandise is normally transported in bags supplied by the merchant, said method comprising:
providing customers with re-usable bags for transporting their merchandise;
providing each customer returning to the store with one or more of the re-usable bags with an award on the acquisition newly acquired merchandise.

2. A method according to claim 1 wherein the award comprises a discount on the newly acquired merchandise.

3. A method according to claim 1 wherein the award comprises a reward in a reward program.

4. A method according to claim 1 wherein the newly acquired merchandise is restricted to selected products.

5. A method according to claim 4 including the step of designating the selected products in response to the receipt of a consideration from the suppliers of the selected products.

6. A method according to claim 1 including placing advertising on the bag.

7. A method according to claim 6 wherein the merchant causes advertising of another party to be placed on the bag response to receipt of a consideration from the other party.

8. A method according to claim 7 wherein the other party is a supplier of merchandise to the merchant.

9. A method according to claim 1 wherein the step of providing customers with the bags comprises selling the bags to the customers.
